(19) United States
(12) Patent Application Publication
(10) Pub. No.: US 2010/0167900 A1
(43) Pub. Date: Jul. 1, 2010

(54) Vertical plate centrifuge

(75) Inventors: Michael D. Rosenblum, Hoboken, NJ (US); H. Gerald Young, South Plainfield, NJ (US)

Correspondence Address: Plevy & Keene LLP, 10 Rutgers Place, Trenton, NJ, 08618, US

(73) Assignee: Labnet International, Inc., Edison, NJ (US)

(21) Appl. No.: 12/317,880

(22) Filed: Dec. 30, 2008

(51) Int. Cl. B04B 7/12; B04B 7/06

(52) U.S. Cl. 494/12; 494/67

(57) ABSTRACT

A Microtiter plate centrifuge is disclosed. The centrifuge includes a motor assembly a shaft, extending vertically from the motor assembly, a rotor assembly, attached to the shaft, the rotor assembly including at least two slots, symmetrically positioned, with respect to the shaft and a channel corresponding to each of said slots. The channels extending from the rotor assembly are suitable for holding Microtiter plates in a vertical position. Also included is a bottom plate engaging a brake pad, which when engaged creates sufficient friction to halt rotation of the rotor assembly.

### FIELD OF THE INVENTION

This invention relates to the field of centrifuge medical devices and, more particularly, to microtiter plate centrifuges.

### BACKGROUND OF THE INVENTION

Methods for separating solid component from fluid are well-known in the medical arts, for example. In application, vials are placed in tube sleeves of a centrifuge and are then spun at various speeds. The centrifugal force generated by the spinning vials causes the heavier particles within the vial to be forced to the outer edge or lower part of the vial.

In another type of centrifuge, for spinning Microtiter and/or PCR plates, the Microtiter and/or PCR plates are placed horizontally in swinging trays and are then spun up to a substantially vertical position. PCR plates represent a specific type of Microtiter plate that is made of thin plastic that allows fast transfer of heat to samples and, thus, they work well for Thermal Cycling applications.

The swing out trays are typically sized to fit common sample plates, whether Microtiter or PCR However, such Microtiter and/or PCR plate centrifuges are relatively large and heavy, e.g., having an approximate 14 inch×14 inc footprint or larger; are expensive; are complicated to operate as speed and run time must be programmed; have a relatively long processing time as the large swing out rotor requires 20 to 40 seconds to reach speed and an equal amount of time to decelerate to a stop and require substantial safety features, such as a lid latching system.

Hence, There is a currently a need for a lightweight and simple to operate Microtiter plate centrifuge.

### SUMMARY OF THE INVENTION

A Microtiter plate centrifuge is disclosed. The centrifuge includes a motor assembly with a shaft, extending vertically from the motor assembly, a rotor assembly, attached to the shaft, the rotor assembly including at least two slots, symmetrically positioned, with respect to the shaft and a channel corresponding to each of said slots. The channels extending from the rotor assembly are suitable for holding Microtiter plates in a vertical position. Also included is a bottom plate engaging a brake pad, which when engaged creates sufficient friction to halt rotation of the rotor assembly.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE FIGURES

In the Drawing

FIG. 1 illustrates a conventional Microtiter plate/PCR plate centrifuge;

FIG. 2 illustrates a prospective view of an exemplary embodiment of a PCR plate centrifuge in accordance with the principles of the invention;

FIG. 3 illustrates a top view of a plate holding rotor of the exemplary PCR plate centrifuge shown in FIG. 2;

FIG. 4 illustrates a cross-sectional view of the exemplary PCR plate centrifuge shown in FIG. 2; and

FIG. 5 illustrates a second cross-sectional view of the exemplary embodiment of the invention shown in FIG. 2.

### DETAILED DESCRIPTION OF THE INVENTION

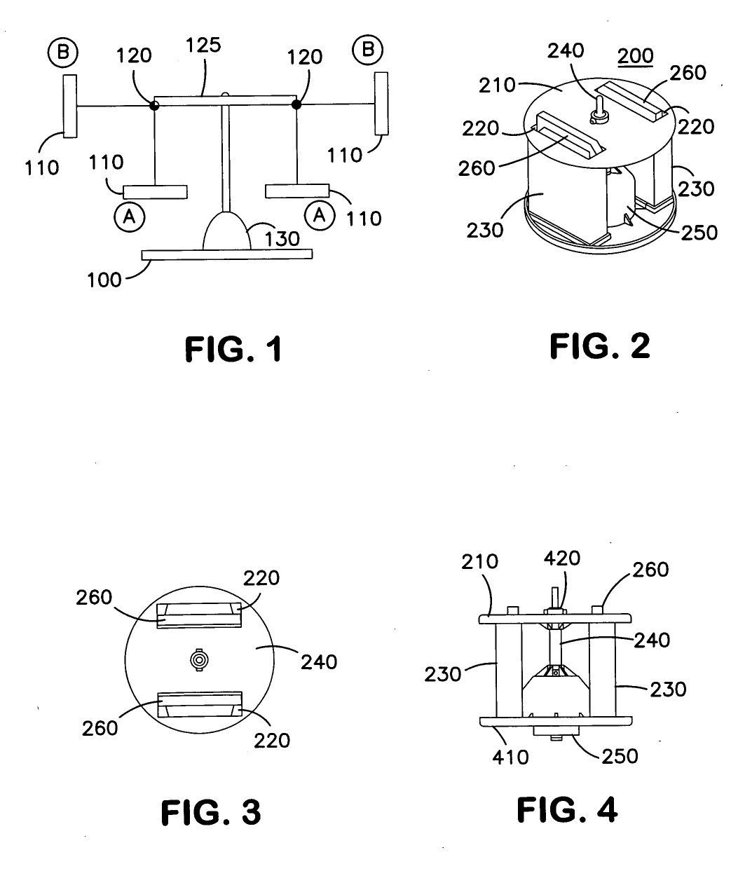

FIG. 1 illustrates a cross-section view of a conventional Microtiter/PCR plate centrifuge 100, wherein generally oppositely positioned horizontal trays 110 (position A) are attached via a gimbaled or hinged connection 120 to a rotatable arm 125. As the rotatable arm 125 is spun up to a desired speed, by an application of an input voltage (not shown) to a motor unit 130, the horizontal trays 110 are swung out to a substantially vertical position (position B). While in this vertical position, any PCR plate (not shown) positioned within trays 110 are also vertically positioned and centrifugal force forces solid materials within the PCR plates to be forced to the bottom of the vials within the PCR plates.

FIG. 2 illustrates a prospective view of an exemplary embodiment of a Microtiter/PCR plate centrifuge 200 in accordance with the principles of the invention. In this exemplary embodiment, a top, rotatable, plate 210 (i.e., a rotor) includes at least one set of substantially oppositely positioned slots 220. Slots 220 represent openings to vertically positioned chambers 230. Plate 210 is further connected to a shaft 240 which is attached to motor assembly 250. Also shown are PCR plate 260 vertically inserted into chambers 230 through openings (slots) 220. In one aspect of the invention, the set of slots 220 is symmetrically positioned with respect to the shaft connection to plate 210

FIG. 3 illustrates a top view of the rotatable plate 210 showing the one set of oppositely positioned slots 220 leading to corresponding chambers, with plates 260 positioned in chambers 230. The use of oppositely positioned chambers provides for balancing of the spinning rotatable plate 210 to avoid vibrations. In addition, one skilled in the art would recognize that more than one set of oppositely positioned slots 220 may be incorporated into plate 210. The number of sets may depend on the size of plate 210, the size of slot 210 and the orientation of adjacent slots.

FIG. 4 illustrates a cross-sectional view of the exemplary Microtiter plate centrifuge shown in FIG. 2. As illustrated, extending substantially perpendicular from top rotatable plate (rotor) 210 are chambers (channels) 230. Plate 210 is held in position on shaft 240 by containment devices 420. Shaft 240 is attached to motor assembly 250. Although channels 230 as shown as having solid walls, it would be recognized that channels 230 may also be composed of a flexible material, e.g., mesh, cloth, etc.

Also shown is bottom plate 410, which provides support for motor assembly 250. Bottom plate 410 may further be attached to a lower end of channels (chambers) 230 to retain channels 230 in a rigid configuration. In this case, the assembly of top plate 210, channels 230 and bottom plate 410 responds as a single unit as the motor assembly 250 causes the rotation of top plate 210. In another aspect of the invention, the chambers may be suspended from the top plate 210 without fixed attachment to the bottom plate 410. In this case, the bottom plate 410 may be attached to shaft 240. Thus, as the top plate 210 and channels 230 are rotated, bottom pate 410 also rotates.

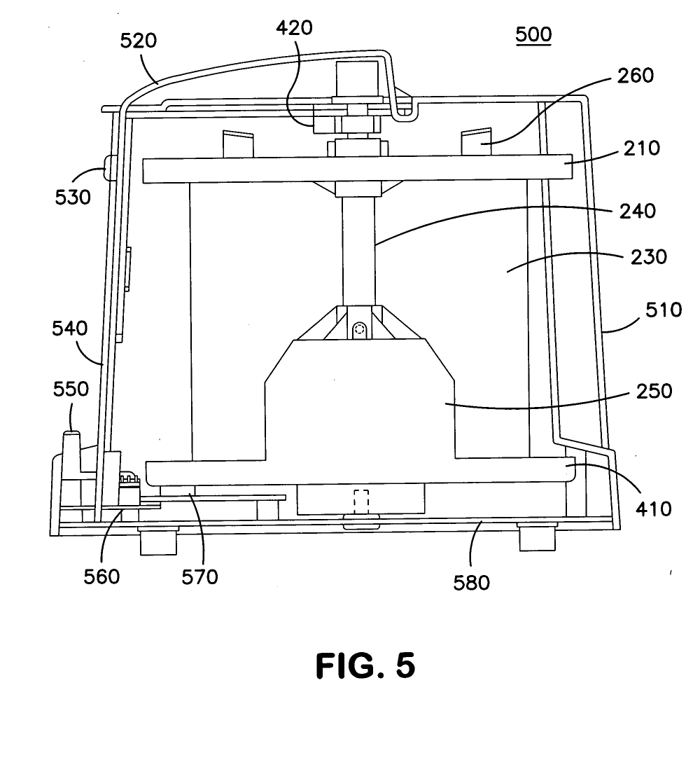

FIG. 5 illustrates a second cross-sectional view of device 500 incorporating the vertical plate centrifuge 200 shown in FIG. 2. Device 500 includes a housing 510 attached to a base plate 580. A lid 520, having a hinged attachment to body (housing) 510 allows access to slot 220 in assembly 200 through an opening in housing 510. In one aspect, lid 520, when open, allows access to at least one slot 220 in top plate 210. The top plate 210 may be manually rotated to allow access to another one of the slots in top plate 210.

Also shown are lid open button 530, which is used to open lid 520. Lid 520 may be spring loaded and when the lid open button 530 is depressed, lid 520 springs open. In addition, when lid 520 is closed, sliding switch 540 is engaged. Sliding switch 540 acts as a safety switch to prevent activation of the motor assembly 250 unless the lid is in a closed position. That is sliding switch 540 prevents/allows a voltage to be applied to run switch 550. Thus, run switch 550 operates in conjunction with slide switch 540 to apply a voltage to motor assembly 250. In addition, when run switch 550 is depressed and held, a brake pad 570, which normally engages bottom plate 410, is moved away from bottom plate 410 to allow bottom plate 410 to rotate as motor assembly 250 causes top plate 210 to rotate. When pressure is removed from run switch 550, brake pad 570 returns to its original position against bottom plate 410. Brake pad 570 creates friction that acts to slow down and stop the rotation of bottom plate 410. As would be recognized, brake pad may be held in a normally engaging position by a spring mechanism (not shown).

Although switch 550 is described as a momentary switch, it would be recognized that switch 550 may be a toggle switch, wherein one depression acts to activate the motor assembly 250 and position brake pad 570 away from the bottom plate 410 and a second depression causes deactivation of the motor assembly 250 and brake pad 570 is positioned against bottom plate 410. In aspect the switch 550 may be a single-pole switch that allows voltage to be applied to motor assembly 250 when in a closed position (for a normally open switch) and in an open position (for a normally closed switch).

While there has been shown, described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A plate holding centrifuge comprising:
a motor assembly;
a shaft, extending vertically from said motor assembly;
a rotor assembly, attached to said shaft, said rotor assembly including at least two slots, symmetrically positioned, with respect to said shaft; and
a channel corresponding to each of said slots.

2. The centrifuge of claim 1, further comprising:
a bottom plate, wherein at least said shaft extends through a center hole in said bottom plate.

3. The centrifuge of claim 2, wherein each of said channels is attached to said bottom plate.

4. The centrifuge of claim 1, further comprising:
a first switch for applying a voltage to said motor assembly.

5. The centrifuge of claim 4, further comprising:
a housing including a lid covering an opening in said housing; and
a second switch, associated with a latch mechanism in said housing, said second switch enabling said voltage to be applied to said first switch.

6. The centrifuge of claim 2, further comprising:
a brake pad normally engaging said bottom plate.

7. The centrifuge of claim 6, wherein said brake pad is spring mounted.

8. A vertical engaging Mircotiter plate centrifuge comprising:
a housing including an opening,
a lid attached to said housing, covering said opening when in a closed position;
a centrifuge assembly within said housing comprising:
a motor assembly attached to and vertically positioned with respect to a bottom of said housing:
a shaft extending from said motor assembly:
a rotor attached to said shaft, said rotor including at least one set of slots symmetrically positioned on said rotor with respect to said shaft attachment;
a channel extending from each of said at least one set of slots; and
a bottom plate including a center hole through which at least said shaft, wherein said bottom plate and said rotor are rotable with respect to said motor assembly;
a brake pad assembly normally engaging said bottom plate; and
a first switch for applying a voltage to said motor assembly and releasing said brake pad.

9. The centrifuge of claim 8, wherein said channels are attached to said bottom plate.

10. The centrifuge of claim 8, wherein said bottom plate is attached to said shaft.

11. The centrifuge of claim 8, further comprising:
a latching switch, which allows a voltage to be applied to said first switch when said lid is in the closed position.

12. The centrifuge of claim 8, wherein said first switch is selected from the group consisting of: momentary, toggle, and single-pole switches.

13. The centrifuge of claim 8, wherein said brake pad assembly includes a spring assembly to engage said brake pad with said bottom plate.

14. The centrifuge of claim 13, wherein said depression of said first switch releases said brake pad from said bottom plate.
